(19) United States
(12) Patent Application Publication
(10) Pub. No.: US 2003/0116273 A1
(43) Pub. Date: Jun. 26, 2003

(54) Method of bonding an optical part

(76) Inventors: Koichiro Nakamura, Osaka-shi (JP); Hiroko Shikata, Osaka-shi (JP); Hiroaki Yamamoto, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/259,436

(22) Filed: Sep. 30, 2002

(30) Foreign Application Priority Data
Oct. 1, 2001 (JP) 2001-304942
Oct. 23, 2001 (JP) 2001-325531

(51) Int. Cl. B32B 7/00

(52) U.S. Cl. 156/330; 156/310; 156/314

(57) ABSTRACT

A method of bonding an optical part, comprising the steps of applying a primer composition which comprises a trialkoxysilane having an epoxy group or alkenyl group, tetraalkoxysilane, Ti, Al or Zr alkoxide and a solvent to the surface of an optical part to be bonded, placing an epoxy resin or silicon resin adhesive composition between the optical part and another optical part and curing it.

The method of bonding an optical part provides excellent heat resistance and bonding strength, suppresses the production of bubbles during curing and is free from a defect such as clouding caused by bubbles.

### FIELD OF THE INVENTION

The present invention relates to a method of bonding an optical part and, particularly, to a method of bonding an optical part such as an optical fiber by an adhesive.

### DESCRIPTION OF THE PRIOR ART

Technologies for expanding communication capacity are now becoming more and more important due to the spread of the Internet. Bonding technologies used to assemble optical parts and optical devices for use in optical fiber communication systems need high reliability and excellent characteristic properties such as precise matching of refractive index (for bonding optical paths), precise positioning accuracy (for bonding lenses) and high heat resistance (solder heat resistance and heat resistance at the time of vacuum film formation). It is known that an organic adhesive such as an epoxy resin is used to assemble optical parts. For example, JP-A 9-176606 (the term “JP-A” as used herein means an “unexamined published Japanese patent application”) discloses that optical parts are bonded together by means of a thermally/photo curable resin composition material which comprises bisphenol A epoxy resin, 1,6-hexanediol, hydrogenated bisphenol A, spherical molten silica, optically cationic curing initiator and thermally cationic curing initiator. JP-A 9-243870 discloses that an optical part is sealed with a photo curable resin composition material which comprises a bisphenol epoxy resin, novolak epoxy resin, photo acid generator and epoxysilane as a coupling agent. Also there have been proposed adhesives such as organic-inorganic composite materials obtained by a sol-gel method for assembling optical parts. For example, JP-A 62-297369 discloses that an optical device is bonded by an adhesive which comprises a hydrolysate of a silicon alkoxide. It is also disclosed in Intl. Congr. On Glass, pages 429 to 436, 1986 that glass is bonded by a sol-gel organic-inorganic adhesive which comprises dichloromethylvinylsilane, dichlorodiphenylsilane and tetraalkoxysilane. Further, U.S. Pat. No. 5,991,493 discloses an optical device manufactured using an organic-inorganic composite adhesive, for example, an adhesive obtained by hydrolyzing a sol comprising polydimethylsiloxane, methyltriethoxysilane and phenyltrifluorosilane.

However, since alcohol produced by a hydrolytic reaction and water produced by a dehydration reaction are gasified during curing by heating in the above technologies for bonding an optical part, bubbles remain in an optical part such as a lens, the optical part becomes cloudy, or sufficient adhesion is not obtained when the optical part is bonded.

### SUMMARY OF THE INVENTION

It is an object of the present invention to provide a method of bonding an optical part, which solves the above problems, provides excellent heat resistance and excellent bonding strength, suppresses the production of bubbles during curing and is free from a defect such as clouding caused by bubbles.

It is another object of the present invention to provide a primer composition for bonding suitably used in the bonding method of the present invention.

Other objects and advantages of the present invention will become apparent from the following description.

According to the present invention, firstly, the above objects and advantages of the present invention are attained by a method of bonding an optical part (may be referred to as “first bonding method” hereinafter), comprising the steps of:

applying a primer composition (may be referred to as “first primer composition” hereinafter) which comprises (A) 100 parts by weight of a silane compound represented by the following formula (1):

R¹Si(OR²)₃ (3)

wherein R¹ is an epoxy group-containing group and R² is an alkyl group,

(B) 5 to 500 parts by weight of a silane compound represented by the following formula (2):

Si(OR³)₄ (2)

wherein R³ is an alkyl group,

(C) 5 to 500 parts by weight of a metal alkoxide represented by the following formula (3):

M(OR⁴)ₙ (3)

wherein M is Ti, Al or Zr, R is an alkyl group or trialkoxysilyl group, and n is 4 when M is Ti or Zr and n is 3 when M is Al, with the proviso that one of three R⁴'S can be a trialkoxysilyl group when M is Al, and (D) a solvent, to the surface of an optical part to be bonded;

placing an epoxy resin adhesive composition between the primer composition coated surface of the optical part and the surface of another part to be bonded to the above optical part; and

curing the epoxy resin adhesive composition.

According to the present invention, secondly, the above objects and advantages of the present invention are attained by a method of bonding an optical part (may be referred to as “second bonding method” hereinafter), comprising the steps of:

applying a primer composition (may be referred to as “second primer composition” hereinafter)which comprises (B) 100 parts by weight of a silane compound represented by the following formula (2):

Si(OR³)₄ (2)

wherein R³ is an alkyl group,

(A′) 5 to 500 parts by weight of a silane compound represented by the following formula (1′):

R¹Si(OR¹)₃ (1′)

wherein R⁵ is an alkenyl group and R⁶ is an alkyl group,

(C) 5 to 500 parts by weight of a metal alkoxide represented by the following formula (3):

M(OR⁴)ₙ (3)

wherein M is Ti, Al or Zr, R is an alkyl group or trialkoxysilyl group, and n is 4 when M is Ti or Zr and n is 3 when M is Al, with the proviso that one of three R⁴'S can be a trialkoxysilyl group when M is Al, and

(D) a solvent, to the surface of an optical part to be bonded;

placing a silicon resin adhesive composition between the primer composition coated surface of the optical part and another part to be bonded to the above optical part; and

curing the silicon resin adhesive composition.

Finally, according to the present invention, the above objects and advantages of the present invention are, thirdly, attained by the above first primer composition of the present invention.

### DETAILED DESCRIPTION OF THE PREFERRED EMBODIMENT

The present invention will be described in detail hereinunder. A description is first given of the first bonding method and the first primer composition of the present invention.

The first primer composition of the present invention comprises the compounds represented by the above formulas (1), (2) and (3). The silane compound (component (A)) represented by the above formula (1) is a raw material for introducing a covalent bond between an adherend surface and an adhesive layer. Since the compound represented by the formula (1) contains an epoxy group, the epoxy bond chemically reacts with the functional group of the adhesive layer to form a covalent bond, thereby increasing adhesive force. Examples of the group R¹ containing the epoxy group in the formula (1) include 3,4-epoxycyclohexylethyl group, γ-glycidoxypropyl group, 3,4-epoxycyclohexylpropyl group, 2,3-epoxybutoxypropyl group, glycidyloxyphenyl group, glycidylphenyl group and 1,2-epoxy-4,4,5,5-tetrafluoroheptyl group. Preferred examples of the alkyl group R 2in the formula (1) include alkyl groups having 1 to 4 carbon atoms such as methyl group, ethyl group, propyl group and butyl group. Examples of the compound represented by the formula (1) include 2-(3,4-epoxycyclohexylethyl)trialkoxysilanes such as 2-(3,4-epoxycyclohexylethyl)trimethoxysilane and 2-(3,4-epoxycyclohexylethyl)triethoxysilane, and γ-glycidoxypropyltrialkoxysilanes such as γ-glycidoxypropyltrimethoxysilane and γ-glycidoxypropyltriethoxysilane. Hydrolysates and polycondensates of the above compounds and oligomers thereof may be used as a raw material.

The silane compound (component (B)) represented by the formula (2) provides a silica component through a hydrolysis/polycondensation reaction. This silica component contributes not only to the improvement of adhesion between the surface of an optical part which is an adherend and an adhesive layer but also to the improvement of the heat resistance, humidity resistance, chemical resistance and mechanical strength of the adhesive layer and the control of linear expansion coefficient of the adhesive layer. Examples of the alkyl group R³ in the formula (2) include methyl group, ethyl group, propyl group and butyl group. Examples of the compound represented by the formula (2) include tetraalkoxysilanes such as tetraethoxysilane, tetramethoxysilane and tetrabutoxysilane. Tetraethoxysilane is preferred because it is easily acquired. Hydrolysates and polycondensates of the above compounds and oligomers thereof may be used as a raw material.

When the content of the component (B) in the primer composition is too low, the above effect of increasing adhesive force is not obtained and when the content is too high, cracking readily occurs due to shrinkage. Therefore, the amount of the component (B) is preferably 5 to 500 parts by weight, more preferably 15 to 150 parts by weight based on 100 parts by weight of the component (A).

The metal alkoxide (component (C)) represented by the above formula (3) serves as a catalyst for the hydrolysis/dehydration condensation reaction of the components (A) and (B) providing an effect to promote the reaction at a low temperature and also contributes to the improvement of chemical and mechanical durabilities of a bond portion by forming silica and a composite metal oxide. It also has the effect (passivation effect) of shutting off ions and alkali components eluting from the optical part which is an adherend to the outside. Examples of the alkyl group R⁴in the formula (3) include methyl group, ethyl group, propyl group and butyl group. Examples of the metal alkoxide (titanium alkoxide) of the formula (3) in which M is Ti (titanium) include titanium tetraisopropoxide, titanium tetranormalbutoxide and chelate compounds thereof. Examples of the aluminum alkoxide of the formula (3) in which M is Al (aluminum) include aluminum-tri-sec-butoxide. Examples of the zirconium alkoxide of the formula (3) in which M is Zr (zirconium) include zirconium tetraisopropoxide and zirconium tetrabutoxide. They may be used directly or in the form of a chelate compound or a hydrolysate. Examples of the aluminum compound of the formula (3) in which R⁴ is a trialkoxysilyl group include di-sec-butoxyaluminoxytriethoxysilane. These metal alkoxides may be an oligomer. When the content of the component (C) in the primer composition is too low, the above effect of improving the durability of a bond portion is not obtained and when the content is too high, it is difficult to increase the thickness of a coating film and the film becomes fragile. Therefore, the amount of the component (C) is preferably 5 to 500 parts by weight, more preferably 15 to 150 parts by weight based on 100 parts by weight of the component (A).

The method of forming the first primer composition from the components (A), (B) and (C) of the present invention will be described hereinunder. (i) A hydrolytic reaction and a dehydration reaction among the compounds represented by the formulas (1), (2) and (3) are carried out in the presence of water, a solvent and a catalyst (acid or base) and the obtained product is applied to the surface of the adherend, or (ii) these components are directly applied to the surface of the adherend without carrying out hydrolysis and then a hydrolytic reaction is carried out using water contained in the air.

Examples of the solvent used for the primer composition include polar solvents such as methanol, ethanol, isopropanol, butanol, isobutanol, hexanol, 2-ethoxyethanol, 2-methoxymethanol and diacetaldehyde, and nonpolar solvents such as hexane, octane and isooctane. The solvent is used in such an amount that ensures that the total amount of the components (A), (B) and (C) should be 3 to 60 wt % of the primer composition. Preferred examples of the catalyst include acid catalysts such as formic acid, acetic acid, butanoic acid, oxalic acid, hydrochloric acid, nitric acid and sulfuric acid and basic catalysts such as aqueous solutions of ammonia, sodium hydroxide and potassium hydroxide.

A description is subsequently given of the first bonding method of the present invention.

In the present invention, the above primer composition is applied to the surface to be bonded of an optical part and left as it is for 30 seconds to 60 minutes, for example, to be dried, an adhesive composition is applied to the surface, and the optical part is pressed against the surface of another part to be bonded to the part. Alternatively, the primer composition is applied and cured by heating at 150° C. or less for 10 seconds to 10 minutes, for example, or by exposure to ultraviolet radiation, and then an adhesive composition is applied to the surface. After the application of the adhesive composition, it is cured at normal temperature or by heating or by exposure to ultraviolet radiation. When the thickness of the film of the primer composition is too small, the obtained film becomes like an island, thereby reducing its effect and when the thickness is too large, it takes time to cure the film. Therefore, the thickness of the film of the primer composition after curing is preferably 10 to 500 nm. The thickness of the film of the adhesive composition after curing is preferably 0.5 to 200 μm.

In the first bonding method, an epoxy resin adhesive composition is used as the adhesive composition. The epoxy resin adhesive composition may be normal-temperature curable, thermally curable or photo curable. Out of these, an adhesive composition which comprises a chief agent containing at least one, preferably both of a bisphenol epoxy resin and a novolak epoxy resin and a curing agent comprising imidazole is preferred. More preferred is an adhesive composition which comprises (E) 3 to 60 wt % of an epoxysilane represented by the following formula (4):

RₙSiX₄₋ₙ (4)

wherein n is 1 or 2, R is an organic group having an epoxy bond when n is 1, and at least one of R's is an organic group having an epoxy bond and the other R than it is an organic group having no epoxy group when n is 2, and X is a hydrolyzable group or atom, or a hydrolysate or polycondensate thereof, (F) 5 to 90 wt % of a bisphenol epoxy resin, (G) 5 to 35 wt % of a novolak epoxy resin, (H) 3 to 30 wt % of a curing agent comprising an amine and (J) 0 to 0.75 time the number of moles of the hydrolyzable group or atom of the above epoxysilane of water and alcohol, the above wt % being based on 100 wt % of the total of the components (E), (F) and (G).

This adhesive composition will be described in detail hereinunder.

The component (E) in the above adhesive composition strengthens bonding between the surface of the adherend and the adhesive and contributes to the improvement of humidity resistance. The compound used as the component (E) is a silane compound having one organic group with an epoxy bond and three hydrolyzable groups or atoms when n is 1, as shown in the above formula (4), or a hydrolysate or polycondensate thereof. When n is 2, the compound is a silane compound having one or two organic groups with an epoxy bond and two hydrolyzable groups or atoms, or a hydrolysate or polycondensate thereof. When the compound has one organic group with an epoxy group, it has one organic group without an epoxy bond, such as alkyl group, aryl group or alkenyl group. An epoxysilane of the above formula (4) in which n is 1, or a hydrolysate or polycondensate thereof is preferred because excellent heat resistance and humidity resistance are obtained. Examples of the organic group having an epoxy bond include glycidoxypropyl group and 3,4-epoxycyclohexyl group. The glycidoxypropyl group and 3,4-epoxycyclohexyl group are preferred as they are easily acquired. The hydrolyzable group X is, for example, an alkoxyl group. An alkoxyl group having 1 to 4 carbon atoms is particularly preferred. The hydrolyzable atom X is, for example, a halogen atom. A chlorine atom is particularly preferred. Preferred examples of the silane compound represented by the above formula (4) include 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, 3-glycidoxypropylmethyldimethoxysilane, 3-glycidoxypropylmethyldiethoxysilane, di(3-glycidoxypropyl)diethoxysilane, di(3-glycidoxypropyl)dimethoxysilane and hydrolysates and polycondensates thereof.

The component (E) may be a silane compound represented by the above formula (4), or a hydrolysate or polycondensate thereof. When a hydrolysate or polycondensate is used, a reaction is carried out while alcohol and water by-produced by the reaction are distilled off to ensure that water and alcohol should not be substantially contained in the adhesive composition. When the component (E) is a silane compound represented by the above formula (4), if the amount thereof is too large, the viscosity of the adhesive composition will become too low, thereby deteriorating coatability. If the amount is too small, the effect of improving humidity resistance will not be obtained fully. When the component (E) is a hydrolysate or polycondensate of a silane compound represented by the above formula (4), if the amount thereof is too large, the viscosity of the composition will become too high, or the amounts of alcohol and water by-produced by hydrolysis will be relatively large with the result that the cured product becomes porous or cloudy. If the amount is too small, the effect of improving humidity resistance will not be obtained fully. Therefore, the amount of the component (E) is 3 to 60 wt %, preferably 6 to 50 wt %, more preferably 8 to 40 wt % based on 100 wt % of the total of the components (E), (F) and (G).

The bisphenol epoxy resin which is the component (F) forms the basic skeleton of the adhesive layer. The molecular weight, accordingly, chemical structure of the bisphenol epoxy resin is controlled to adjust the viscosity of the adhesive composition to 2,000 to 5,000 mPa·s. The adhesive composition having a viscosity within this range is easily applied. The component (F) is, for example, bisphenol A epoxy resin, bisphenol F epoxy resin or bisphenol S epoxy resin. Out of these, bisphenol F epoxy resin is preferred. When the amount of the component (F) is too large, heat resistance and humidity resistance lower and when the amount is too small, its compatibility with other components deteriorates. The amount of the component (F) is 5 to 90 wt %, preferably 20 to 80 wt %, more preferably 40 to 75 wt % based on 100 wt % of the total of the components (E), (F) and (G).

The component (G) is a novolak epoxy resin for improving the heat resistance of the adhesive layer. When the amount of the component is too large, the viscosity of the adhesive composition becomes too high and when the amount is too small, heat resistance is not fully improved. Therefore, the amount of the component (G) is 5 to 35 wt %, preferably 8 to 30 wt %, more preferably 12 to 28 wt % based on 100 wt % of the total of the components (E), (F) and (G).

The amine which is the component (H) is a curing catalyst for polymerizing the epoxy bonds of the components (E), (F) and (G). The component (H) also serves as a hydrolytic catalyst for the component (E). The component (H) is, for example, a primary amine, secondary amine or tertiary amine. Examples of the component (H) include diethylenetriamine, triethylenetetramine, polymethylenediamine, methaphenilenediamine, diaminodiphenylmethane, imidazole, 2-methylimidazole and 2-ethyl-4-methylimidazole. Out of these, imidazoles, that is, imidazole, 2-methylimidazole and 2-ethyl-4-methylimidazole are preferred because they have excellent reactivity. The amount of the component (H) is 3 to 30 wt %, preferably 4 to 25 wt %, more preferably 5 to 20 wt % based on 100 wt % of the total of the components (E), (F) and (G).

It is preferred that the above adhesive composition should not contain volatile components such as alcohol and water in large quantities. When it contains volatile components, the cured product may become porous or cloudy. When a hydrolysate or polycondensate of an epoxysilane is used as the component (E), it is preferred that the total content of water and alcohol in the component (E), accordingly, the adhesive composition be reduced as much as possible by carrying out a reaction while the by-produced alcohol and water are distilled off to prepare the hydrolysate or polycondensate. When an epoxysilane not hydrolyzed is used as the component (E), water for hydrolyzing this epoxysilane must be contained in the adhesive composition. Therefore, water is preferably contained in the adhesive composition in an amount 0.5 to 0.75 time the number of moles of the hydrolyzable group or atom of the epoxysilane. This water does not need to be especially added and water contained in the components (F) and (G) as an impurity is enough. When the hydrolytic and dehydration reactions of the epoxy silane occur in the adhesive composition, part of the contained water is converted into alcohol. Therefore, total amounts of water and alcohol as the component (J) are contained in the adhesive composition in an amount 0 to 0.75 time the number of moles of the hydrolyzable group or atom of the epoxysilane (the total number of moles when the group and atom are both contained). More specifically, the total content of alcohol and water in the adhesive composition is maintained at preferably 1 wt % or less, more preferably 0.1 wt % or less.

The contents of the above epoxysilane, bisphenol epoxy resin and novolak epoxy resin in the above adhesive composition are controlled to ensure that the refractive index value of the adhesive layer should be approximate to the refractive index values of at least two optically transparent optical parts. Stated more specifically, when the refractive indices of two adjacent optical parts are represented by n₁ and n₂ (n₁≧n₂), the adhesive layer between the adjacent optical parts preferably has a refractive index n₃ represented by the following expression (I). More preferably, this adhesive layer has a refractive index n₃ represented by the following expression (II).

$$\begin{matrix}√ ( {n}_{1} \cdot {n}_{2} ) - ( ( √ ( {n}_{1} \cdot {n}_{2} ) - {n}_{2} ) / 3 ) - 0.05 ≦ {n}_{3} ≦ √ ( {n}_{1} \cdot {n}_{2} ) + ( ( {n}_{1} - √ ( {n}_{1} \cdot {n}_{2} ) ) / 3 ) + 0.05 & ( I ) \\ √ ( {n}_{1} \cdot {n}_{2} ) - ( ( √ ( {n}_{1} \cdot {n}_{2} ) - {n}_{2} ) / 10 ) - 0.01 ≦ {n}_{3} ≦ √ ( {n}_{1} \cdot {n}_{2} ) + ( ( {n}_{1} - √ ( {n}_{1} \cdot {n}_{2} ) ) / 10 ) + 0.01 & ( II )\end{matrix}$$

For example, to connect an optical fiber having a refractive index (n₂) of 1.46 to a microlens having a refractive index (n₁) of 1.59, according to the above expression (1), 1.452≦n₃≦1.596 and according to the above expression (2), 1.507≦n₃≦1.540. Thus, by adjusting the refractive index, an optical device having a low light transmission loss is obtained. As for optical fibers, lenses, filters, optical waveguides, diffraction gratings and optically active elements, an optical device having a low light transmission loss is provided by adjusting their refractive indices.

To bond these optical parts, an optically transparent adhesive composition is applied, filled or spread between the first optical part and the second optical part whose surfaces have been coated with the above primer composition and cured to form a bond portion having predetermined strength. As for curing the adhesive, when the amount of a curing agent is increased, an adhesive composition which is cured in several minutes can be obtained and when the amount is reduced, an adhesive composition having a pot life of several hours can be obtained. The curing time can be shortened by heating as required. A reaction retardant or curing accelerator may be added as required in an amount of 40 wt % or less, preferably 30 wt % or less based on the total amount. By adding a reaction retardant or curing accelerator, the curing time can be freely controlled. After the adhesive composition is applied, it is generally maintained at room temperature to 250° C. for several minutes to several hours to be cured.

Examples of the optical part of the present invention include lenses, prisms, diffraction gratings and filters made from quartz glass or oxide glass such as silicate glass, holding members therefor and ferrules. The lenses include gradient refractive index (GRIN) lenses, aspherical lenses, Fresnel lenses and lenticular lenses.

The first bonding method of the present invention is used to bond glass or non-glass lenses or optical fibers to each other, or an optical part such as a lens or fiber to another part, such as a member for supporting the optical part or a ferrule. The first primer composition of the present invention is applied to the surface to be bonded of an optical part. More specifically, the first bonding method of the present invention can be used to bond glass optical fibers or glass GRIN lenses to each other, a glass GRIN lens to a glass optical fiber, a glass optical fiber to a ceramic ferrule, a glass optical fiber to an inorganic oxide band pass filter, a glass optical fiber to a glass waveguide element, or a glass optical fiber to a glass waveguide diffraction grating.

The member (substrate) for supporting an optical part such as a lens or optical fiber is made from glass, semiconductor, ceramic or polymer. Examples of the glass include quartz glass, float glass, low-expansion heat resistant glass and crystallized glass. Examples of the semiconductor include silicon, InP and GaAs. The substrate may have a groove or hole for fixing an optical part. Examples of the grooved substrate include a glass substrate having a V-shaped groove and a silicon substrate having a V-shaped groove formed by etching.

A description is subsequently given of the second bonding method and the second primer composition of the present invention.

The second primer composition of the present invention comprises the compounds represented by the above formulas (1′), (2) and (3). The silane compound (component (B)) represented by the formula (2) provides a silica component through a hydrolysis/polycondensation reaction. This silica component contributes not only to the improvement of adhesion between the surface of a glass optical part which is an adherend and an adhesive layer but also to the improvement of the heat resistance, humidity resistance, chemical resistance and mechanical strength of the adhesive layer and the control of linear expansion coefficient of the adhesive layer. Examples of the compound represented by the formula (2) include tetraalkoxysilanes such as tetraethoxysilane, tetramethoxysilane and tetrabutoxysilane. Tetraethoxysilane is preferred because it is easily acquired. Hydrolysates and polycondensates of the above compounds and oligomers thereof may be used as a raw material.

The silane compound (component (A′)) represented by the above formula (1′) is a raw material for introducing a covalent bond between the surface of the adherend and the adhesive layer. Since the compound represented by the formula (1′) contains an alkenyl group (R⁵) such as vinyl group, vinyloxy group, allyl group, allyloxy group, methacryl group, methacryloxy group, methacryloxyalkyl group, acryl group, acryloxy group, acryloxyalkyl group, 1-butenyl group, heptenyl group or hexenyl group, a carbon-carbon double bond thereof chemically reacts with the functional group of the adhesive layer to form a covalent bond, thereby increasing adhesive force. Examples of the compound represented by the formula (1′) include vinyltrialkoxysilanes such as vinyltriethoxysilane and vinyltrimethoxysilane, allyltrialkoxysilanes such as allyltriethoxysilane and allyltrimethoxysilane, methacryloxypropyltrialkoxysilanes such as methacryloxypropyltriethoxysilane and methacryloxypropyltrimethoxysilane, and acryloxypropyltrialkoxysilanes such as acryloxypropyltiethoxysilane and acryloxypropyltrimethoxysilane. Hydrolysates and polycondensates of the above compounds or oligomers thereof may be used as a raw material. When the content of the component (A′) in the primer component is too large, the denseness of the film is lost. Therefore, the amount of the component (A′) is preferably 5 to 500 parts by weight, more preferably 10 to 100 parts by weight based on 100 parts by weight of the component (B).

The metal alkoxide (component (C)) represented by the above formula (3) serves as a catalyst for the hydrolysis/dehydration condensation reaction of the components (B) and (A′) to promote the reaction at a low temperature and also contributes to the improvement of chemical and mechanical durabilities of a bond portion by forming silica and a composite metal oxide. It also has the effect (passivation effect) of shutting off ions and alkali components eluting from the glass optical part which is an adherend to the outside, thereby contributing to the improvement of the humidity resistance of an optical part to be bonded. Examples of the component (C) are the same as the above compounds listed for the first primer composition. When the content of the component (C) in the primer composition is too high, the number of bonding sites with the adhesive layer is reduced. Therefore, the amount of the component (C) is preferably 5 to 500 parts by weight, more preferably 10 to 100 parts by weight based on 100 parts by weight of the component (B).

The method of forming the primer composition from the components (B), (A′) and (C) of the present invention will be described hereinunder. (i) A hydrolytic reaction and a dehydration reaction among the compounds represented by the formulas (2), (1′) and (3) are carried out in the presence of water, a solvent and a catalyst (acid or base) and the obtained product is applied to the surface of the adherend, or (ii) these components are directly applied to the surface of the adherend without carrying out hydrolysis and then a hydrolytic reaction is carried out using water contained in the air.

Examples of the solvent and the catalyst used for the second primer composition are the same as those listed for the first primer composition.

In the present invention, the above second primer composition is applied to the surface of a glass optical part and left as it is for 30 seconds to 60 minutes, for example, to be dried, an adhesive composition is applied to the surface, and the optical part is pressed against the surface of another part to be bonded to the part. Alternatively, the primer composition is applied and cured by heating at 150° C. or less for 10 seconds to 10 minutes, for example, or by exposure to ultraviolet radiation, and then an adhesive composition is applied to the surface. The thickness of the film of the second primer composition after curing is preferably 0.05 to 1 nm. The thickness of the film of the adhesive composition after curing is preferably 0.5 to 250 μm.

In the present invention, a silicon resin adhesive composition is used as the adhesive composition. The silicon resin adhesive composition may be normal-temperature curable, thermally curable or optically curable. Out of these, preferred is an adhesive composition which comprises (K) an organopolysiloxane having at least two alkenyl groups with 4 or less carbon atoms bonded to a silicone atom in one molecule, (L) an organohydrogenpolysiloxane having at least two hydrogen atoms bonded to a silicon atom in one molecule and (M) a metal catalyst. The adhesive composition will be described in detail hereinunder.

Examples of the organopolysiloxane compound having at least two alkenyl groups with 4 or less carbon atoms bonded to a silicon atom in one molecule (component (K)) include polydimethylsiloxane compounds having hydrogen at a terminal, methylhydrogensiloxane-dimethylsiloxane copolymer compounds, polymethylhydrogensiloxane compounds, polyethylhydrogensiloxane compounds, polyphenyl(dimethylhydrogensiloxy)siloxane compounds having hydrogen at a terminal, methylhydrogensiloxane-phenylmethylsiloxane copolymer compounds and methylhydrogensiloxane-octylmethylsiloxane copolymer compounds having a vinyl group, vinyloxy group (2 carbon atoms), allyl group, allyloxyl group (3 carbon atoms), acryl group, acryloxy group (2 carbon atoms), methacryl group or methacryloxy group (3 carbon atoms). Out of these, dimethylsiloxane polymers having a vinyl group at both terminals represented by the following formula (5), vinylmethylsiloxane-dimethylsiloxane copolymers represented by the following formula (6), diphenylsiloxane-dimethylsiloxane copolymers having a vinyl group at both terminals represented by the following formula (7) and methyltrimethylpropylsiloxane-dimethylsiloxane having a vinyl group at both terminals represented by the following formula (8) are preferred. The component (K) preferably has a viscosity at 25° C. of 100 to 250,000 cS from the viewpoint of coating work efficiency.

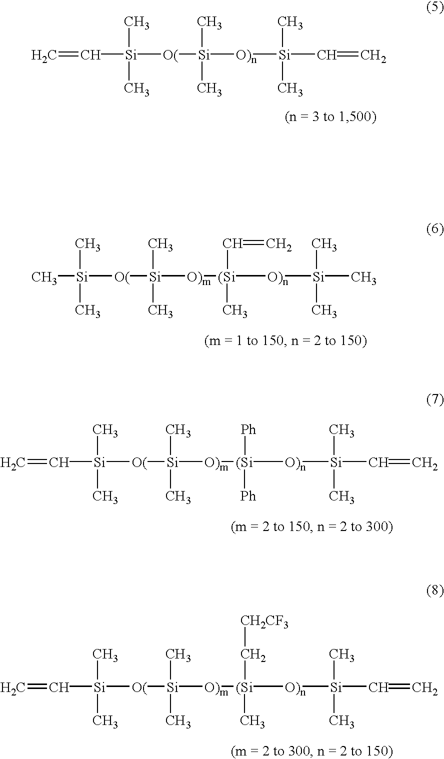

Examples of the organohydrogenpolysiloxane compound having at least two hydrogen atoms bonded to a silicon atom in one molecule (component (L)) include polydimethylsiloxane compounds having hydrogen at a terminal represented by the following formula (9), methylhydrogensiloxane-dimethylsiloxane copolymer compounds represented by the following formula (10), polyphenyl(dimethylhydrogensiloxane)siloxane compounds having hydrogen at a terminal represented by the following formula (11), and methyltrifluoropropylsiloxane(dimethylsiloxane)copolymer compounds, polymethylhydrogensiloxane compounds represented by the following formula (12), polyethylhydrogensiloxane compounds and methylhydrogensiloxane-phenylmethylsiloxane copolymer compounds.

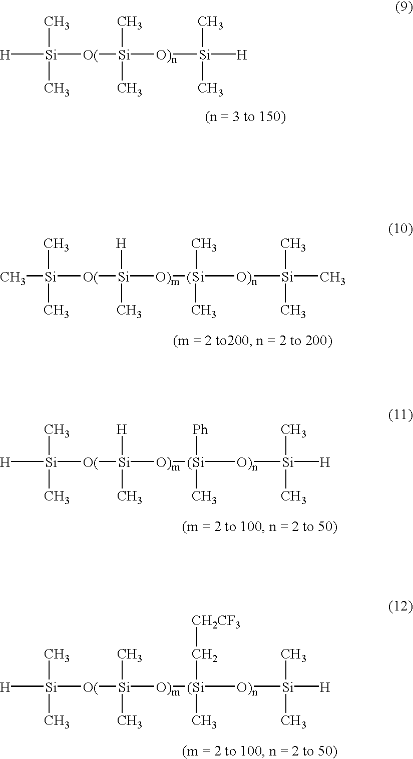

The metal catalyst (component (M)) used in the adhesive composition of the present invention is preferably a platinum-based catalyst such as a platinum-siloxane complex, platinum-olefin complex, platinum-(β-diketone)complex or platinum-azo complex. Specific preferred examples of the metal catalyst include platinum-carbonylvinylmethyl complex, platinum-divinyltetramethyldisiloxane complex, platinum-cyclovinylmethylsiloxane complex, and platinum-octylaldehyde/octanol complex.

As for the contents of the component (K) and component (L) in the adhesive composition, the number of hydrogen atoms contained in the component (L) is preferably 0.4 to 6.0 times, more preferably 0.6 to 4.0 times the total number of alkenyl groups contained in the component (K). The above metal catalyst (component (M)) is preferably contained in an amount of 10 to 1,000 ppm based on the total weight of the components (K) and (L) because it can retain a suitable curing rate and have a suitable pot life.

The adhesive composition of the present invention may comprise a tetraalkoxide (trialkoxide in the case of aluminum) of at least one network-forming atom selected from the group consisting of silicon, titanium, zirconium, aluminum and germanium and a condensate of one or more of the above metal alkoxides in a small amount, in addition to the above components (K) to (M). This component may cause the production of bubbles and volume shrinkage due to dehydration or dealcoholation during the curing reaction of the adhesive layer. When the content of the component is 20 wt % or less based on the total weight of the adhesive composition, the above problems will not occur.

The adhesive composition comprising the above components (K) to (M) is more preferably an adhesive composition which comprises (K′) an organopolysiloxane having two alkenyl groups with 4 or less carbon atoms bonded to a silicon atom in one molecule and a molecular weight of 1,000 or more, (L′) an organohydrogenpolysiloxane having at least two hydrogen atoms bonded to a silicon atom in one molecule and a molecular weight of 1,000 or more, (M′) a platinum-based catalyst and (N) at least one of (N-1) an organic silicon compound having at least three alkenyl groups with 4 or less carbon atoms bonded to a silicon atom in one molecule and a molecular weight of less than 1,000 and (N-2) an organic cyclic silicon compound having at least three hydrogen atoms bonded to a silicon atom in one molecule and a molar weight of less than 1,200 because especially high bonding strength is obtained at a high temperature and a high humidity.

As for the contents of the components (K′), (L′), (M′) and (N), the number of hydrogen atoms contained in the components (K′) and (N-2) is 0.4 to 6.0 times the total number of alkenyl groups contained in the above components (K′) and (N-1), the component (M′) is contained in an amount of 10 to 1,000 ppm based on the total weight of the components (K′), (L′) and (N), and the component (N) is contained in an amount of 0.1 to 40 wt % based on the total weight of the components (K′) and (L′).

Examples of the above component (N-1) include boronvinyldimethylsiloxide, hexavinyldisiloxane, methacryloxypropyltris(vinyldimethylsiloxy)silane, octavinyl-T8-silsesquioxane, pentavinylpentamethylcyclopentasiloxane, tetraallyloxysilane, tetraallylsilane, tetrakis(2-methacryloxyethoxy)silane, tetrakis(vinyldimethylsiloxy)silane, 1,1,3,3-tetravinyldimethyldisiloxane, tetravinylsilane, 1,3,5,7-tetravinyl-1,3,5,7-tetramethylcyclotetrasilazane, 1,3,5,7-tetravinyl-1,3,5,7-tetramethylcyclotetrasiloxane, tris(vinyldimethylsiloxy)methylsilane, tris(vinyldimethylsiloxy)phenylsilane, trivinylchlorosilane, trivinylethoxysilane, trivinylmethoxysilane, trivinylmethylsilane, 1,3,5-trivinyl-1,1,3,5,5-pentamethyltrisiloxane, trivinylsilane, 1,3,5-trivinyl-1,3,5-trimethylcyclotrisilazane and 1,3,5-trivinyl-1,3,5-trimethylcyclotrisiloxane.

Examples of the above component (N-2) include hydro-T8-silsesquioxane, octakis(dimethylsiloxy)-T8-silsesquioxane, methylhydrocyclosiloxane, pentamethylcyclopentasiloxane, phenylhydrocyclosiloxane, 1,3,5,7-tetramethylcyclotetrasiloxane, 1,3,5,7-tetraethylcyclotetrasiloxane and 1,3,5,7-tetraethyl-2,4,6,8-tetramethylcyclotetrasilazane.

Examples of the glass optical part of the present invention include lenses, prisms, diffraction gratings and filters which are made from quartz glass or oxide glass such as silicate glass. The lenses include GRIN lenses, aspherical lenses, Fresnel lenses and lenticular lenses.

The second bonding method of the present invention is used to bond two glass optical parts to each other, a glass optical part to a non-glass optical part, or a glass optical part to another part such as a substrate for supporting the optical part or a ferrule. The second primer composition of the present invention is applied to the surface to be bonded of a glass optical part. The above primer composition may be applied to the surface to be bonded of a non-glass optical part, substrate or ferrule. More specifically, the bonding method of the present invention can be used to bond glass optical fibers or glass GRIN lenses to each other, a glass GRIN lens to a glass optical fiber, a glass optical fiber to a ceramic ferrule, a glass optical fiber to an inorganic oxide band pass filter, a glass optical fiber to a glass waveguide element, or a glass optical fiber to a glass waveguide diffraction grating.

The substrate for fixing an optical part of the present invention is made from glass, semiconductor, ceramic or polymer. Examples of the glass include quartz glass, float glass, Pyrex (registered trademark) glass and crystallized glass. Examples of the semiconductor include silicon, InP and GaAs. The substrate may have a groove or hole for fixing an optical part. Examples of the grooved substrate include a glass substrate having a V-shaped groove and a silicon substrate having a V-shaped groove formed by etching.

The following examples are provided to further illustrate the present invention.

### EXAMPLE

### Examples 1 to 6 and Comparative Examples 1 to 6

Preparation of Adhesive Composition 1

0.75 g of bisphenol F epoxy resin (YDF-170 of Toto Kasei Co., Ltd., epoxy equivalent of 160 to 180 g/eq, viscosity of 2,000 to 5,000 mPa·s) and 0.25 g of novolak epoxy resin (YDPN-638 of Toto Kasei Co., Ltd., epoxy equivalent of 170 to 190 g/eq, water content of 1% or less) were mixed together and stirred, and 0.10 g of 4-ethyl-2-methylimidazole as a curing agent was added to the above mixture to obtain an adhesive composition 1.

Preparation of Adhesive Composition 2

0.1 g of 2-(3,4-epoxycyclohexyl)ethyltrimethoxysilane, 0.75 g of bisphenol F epoxy resin (YDF-170 of Toto Kasei Co., Ltd., epoxy equivalent of 160 to 180 g/eq, viscosity of 2,000 to 5,000 mPa·s) and 0.25 g of novolak epoxy resin (YDPN-638 of Toto Kasei Co., Ltd., epoxy equivalent of 170 to 190 g/eq, water content of 1% or less) were mixed together and stirred to obtain a chief agent 1. 1.1 g of 2-ethyl-4-methylimidazole and 0.68 g of imidazole were mixed together and heated at 100° C. for 1 hour to obtain a curing agent. 100 mg of the chief agent 1 and 10 mg of the above curing agent were mixed together to obtain an adhesive composition 2.

Preparation of Adhesive Composition 3

30 parts by weight of bisphenol A epoxy resin (epoxy equivalent of 185), 1 part by weight of 1,6-hexanediol, 1 part by weight of hydrogenated bisphenol A, 1 part by weight of a photo cationic curing initiator (SP150 of Asahi Denka Kogyo K.K.), 0.5 part by weight of a thermally cationic curing initiator (CP66 of Asahi Denka Kogyo K.K.), 10 parts by weight of spherical molten silica having an average particle diameter of 0.5 μm and 56.5 parts by weight of spherical molten silica having an average particle diameter of 6 μm were mixed together and kneaded for 10 minutes to obtain an adhesive composition 3.

Preparation of Primer Compositions 1 to 8

100 parts by weight of 2-(3,4-epoxycyclohexylethyl)triethoxysilane, 50 parts by weight of tetraethoxysilane and 50 parts by weight of tetra-n-butoxytitanium were mixed together and 1,000 parts by weight of hexane was added to and mixed with the above mixture to obtain a primer composition 1. Similarly, the numbers of parts shown in Table 1 of components shown in Table 1 were mixed together to obtain primer compositions 2 to 8. In the table, “epoxysilane” is 2-(3,4-epoxycyclohexyl)ethyltriethoxysilane, “glycidoxysilane” is γ-glycidoxypropyltriethoxysilane, “TidiisoprbisAcAc” is titanium diisopropoxide bis(acetylacetonate), and “dibutoxyAltriethoxysilane” is di-sec-butoxyaluminoxytriethoxysilane. The primer compositions 1 to 5 correspond to Examples 1 to 5 and the primer compositions 6 to 8 correspond to Comparative Example 4 to 6, respectively.

A glass microlens (Selfoc Microlens SMC18 of Nippon Sheet Glass Co., Ltd., glass composition: alkali-containing silicate glass, diameter: 1.8 mm, length: 4.43 mm(0.23 pitch, refractive index of center portion: 1.590, distribution coefficient g=0.326, one pitch (=2π/g)=19.27 mm) was prepared.

Each of the primer compositions 1 to 8 was applied to one end faces of two of the above lens and dried at room temperature for 30 minutes. Thereafter, the adhesive composition 1 or 2 was applied to the primer coated end faces of the lenses which were then pressed against each other to be contacted to each other and then heated at 150° C. for 30 minutes to obtain an adhesive sample. Combinations of the primer compositions 1 to 8 and the adhesive compositions 1 and 2 are shown in Table 2. In the case of Example 6 and Comparative Example 3 in which the adhesive composition 3 was applied, the adhesive composition was exposed to 52.5 mW/cm² of ultraviolet radiation having a wavelength of 365 nm for about 3 seconds instead of heating.

A tensile strength test was made on this adhesive sample to evaluate the bonding strength of the adhesive layer. That is, the glass microlenses on both sides of the adhesive layer were pulled in opposite directions at a rate of 50 cm/min to measure tensile force (Newton (N)) when a rupture occurred. The results are shown in Table 2. It was found from the table that Examples 1 to 5 had a tensile strength of 15N or more. In contrast to this, Comparative Examples 1 to 6 had a tensile strength of less than 5N.

As described above, according to the present invention, there are obtained optical parts bonded by an adhesive layer having excellent bonding strength.

TABLE 1

| | Primer composition | | | | | | | |
|---|---|---|---|---|---|---|---|---|
| | 1 | 2 | 3 | 4 | 5 | 6 | 7 | 8 |
| Epoxysilane | 100 | 100 | 100 | 100 | 0 | 0 | 0 | 100 |
| Glycidoxy- | 0 | 0 | 0 | 0 | 100 | 0 | 0 | 0 |
| silane | | | | | | | | |
| Tetraethoxy- | 50 | 50 | 50 | 50 | 50 | 50 | 0 | 0 |
| silane | | | | | | | | |
| Tetra-n-butoxy- | 50 | 0 | 0 | 0 | 0 | 50 | 50 | 0 |
| titanium | | | | | | | | |
| Tidiisoprbis- | 0 | 0 | 50 | 0 | 0 | 0 | 0 | 0 |
| AcAc | | | | | | | | |
| Tetra-n-butoxy- | 0 | 0 | 0 | 50 | 0 | 0 | 0 | 0 |
| zirconium | | | | | | | | |
| dibutoxyAltri- | 0 | 0 | 0 | 0 | 50 | 0 | 0 | 0 |
| ethoxysilane | | | | | | | | |
| hexane | 1,000 | 1,000 | 1,000 | 1,000 | 0 | 1,000 | 1,000 | 1,000 |
| methanol | 0 | 0 | 0 | 1,000 | 1,000 | 0 | 0 | 0 |

epoxysilane: 2-(3,4-epoxycyclohexyl)ethyltriethoxysilane
glycidoxysilane: γ-glycidoxypropyltriethoxysilane
TidiisoprbisAcAc: titanium diisopropoxide bis(acetylacetonate)
dibutoxyAltriethoxysilane: di-sec-butoxyaluminoxytriethoxysilane

TABLE 2

| | Primer | adhesive | bonding strength |
|---|---|---|---|
| No. | composition No. | composition No. | (N) |
| Ex. 1 | 1 | 1 | 17 |
| Ex. 2 | 2 | 1 | 16 |
| Ex. 3 | 3 | 1 | 18 |
| Ex. 4 | 4 | 2 | 17 |
| Ex. 5 | 5 | 2 | 16 |
| Ex. 6 | 1 | 3 | 17 |
| C. Ex. 1 | none | 1 | 2.3 |
| C. Ex. 2 | none | 2 | 2.8 |
| C. Ex. 3 | none | 3 | 3.0 |
| C. Ex. 4 | 6 | 1 | 3.5 |
| C. Ex. 5 | 7 | 1 | 3.6 |
| C. Ex. 6 | 8 | 2 | 3.9 |

Ex.: Example
C. Ex.: Comparative Example

### Examples 7 to 11 and Comparative Example 7 to 11

Preparation of Adhesive Composition 4

10 g of a dimethylsiloxane having vinyl at both terminals (DMS-V31 of GELEST Co., Ltd.), 1 mg of a platinum-divinyltetramethyldisiloxane complex (SIP6830 of GELEST Co., Ltd.) and 5 g of a methylhydrogensiloxane-dimethylsiloxane copolymer (HMS-301 of GELEST Co., Ltd.) were mixed together to obtain an adhesive composition 4.

Preparation of Adhesive Compositions 5 and 6

A polydimethylsiloxane having vinyl at a terminal (viscosity: 1,000 cS, molecular weight: 28,000, abbreviated as VPDMS) as the component (K′), methylhydrogensiloxane-dimethylsiloxane copolymer (viscosity: 25 to 35 cS, molecular weight: about 2,000, abbreviated as MHS-DMS) as the component (L′), platinum-divinyltetramethyldisiloxane complex as the component (M′), and 1,3,5,7-tetravinyl-1,3,5,7-tetramethylcyclotetrasiloxane (molecular weight: 344.66, abbreviated as TVTMSTS) as the component (N-1) or 1,3,5,7-tetraethyl-2,4,6,8-tetramethylcyclotetrasilazane (molecular weight: 348.78, abbreviated as TETMSTS) as the component (N-2) were mixed together to ensure that the number of hydrogen atoms contained in the components (L′) and (N-2) should be 0.9 time the total number of alkenyl groups contained in the above components (K′) and (N-1) and the amount of the component (M′) should be 100 ppm based on the total weight of the components (K′) to (N) to obtain adhesive compositions 5 and 6 as shown in Table 3.

Preparation of Adhesive Composition 7

1.33 ml of polydimethylsiloxane (PDMS), 35.6 ml of methyltriethoxysilane (MTES) and 2.67 ml of phenyltrifluorosilane (PTFS) were added to a 100 ml sample tube (molar ratio of 8:83:9) and stirred at room temperature for 5 minutes by covering the tube. The obtained mixture was heated at 70° C., and 5.4 g of water was added and violently stirred for 30 minutes. The reaction mixture was first separated into two layers but became uniform later. The mixture was left in the air for 1 day by removing the cover to remove the solvent by natural drying so as to obtain an adhesive composition 7.

10 mg of each of the above adhesive compositions 4 to 7 was dropped on a first slide glass sheet (25 mm×50 mm×1.2 mm), a second slide glass sheet was placed on the first slide glass sheet immediately to spread the adhesive composition to an area of 25 mm×25 mm and heated on a hot plate at 200° C. for 15 minutes, and the appearance of the adhesive layer between the first and second slide glass sheets was observed to check the production of air bubbles and clouding. 1 g of each of the adhesive compositions 4 to 7 was placed in a 3 ml glass sample bottle and heated at 200° C. for 30 minutes to measure the volumes of the adhesive composition before and after heating for the evaluation of volume shrinkage (%) represented by 100×(volume before heating−volume after heating)/(volume before heating). The production of bubbles was not observed during heating in the adhesive compositions 4 to 6 as shown in Table 4 and volume shrinkage was very small. However, bubbles were produced during heating in the adhesive composition 7 as shown in Table 4 and air bubbles continuous from the center to the edges of the glass sheet were produced. Along with the production of gas, marked volume shrinkage was observed.

Preparation of Primer Compositions 9 to 16

100 parts by weight of tetraethoxysilane, 50 parts by weight of vinyltriethoxysilane and 50 parts by weight of tetra-n-butoxytitanium were mixed together and 1,000 parts by weight of hexane was mixed with the above mixture to obtain a primer composition 9. Similarly, the numbers of parts shown in Table 5 of components shown in Table 5 were mixed together to obtain primer compositions 10 to 16.

A glass microlens (Selfoc Microlens SMC18 of Nippon Sheet Glass Co., Ltd., glass composition: alkali-containing silicate glass, diameter: 1.8mm, length: 4.43mm(0.23pitch, refractive index of center portion: 1.590, distribution coefficient g=0.326, one pitch (=2π/g)=19.27 mm) was prepared.

Each of the primer compositions 9 to 16 was applied to one end faces of two of the above lens and dried at room temperature for 30 minutes. Thereafter, each of the adhesive compositions 4 to 7 was applied to the primer coated end faces of the lenses which were then pressed against each other to be contacted to each other and then heated at 150° C. for 30 minutes to obtain an adhesive sample. Combinations of the primer compositions 9 to 16 and the adhesive compositions 4 to 7 are shown in Table 6.

A tensile strength test was made on this adhesive sample to evaluate the bonding strength of the adhesive layer. That is, the glass microlenses on both sides of the adhesive layer were pulled in opposite directions at a rate of 50 cm/min to measure tensile force (Newton (N)) when a rupture occurred. The results are shown in Table 6. It was found from the table that Examples 7 to 11 had a tensile strength of 10N or more. In contrast to this, Comparative Examples 7 to 11 had a tensile strength of less than 2N.

As described above, according to the present invention, there are obtained optical parts bonded by an adhesive layer having excellent bonding strength, a low light transmission loss and excellent environment resistance (heat resistance, weatherability, humidity resistance and chemical resistance) while preventing the production of gas and shrinkage in the step of curing an adhesive.

TABLE 3

| | component (K′) | | component (L′) | | component (N) | | ratio of number of |
|---|---|---|---|---|---|---|---|
| | | amount | | amount | | amount | hydrogen atoms to total |
| Adhesive | type | (wt %) | type | (wt %) | type | (wt %) | number of alkenyl groups |
| 5 | VPDMS | 90 | MHS-DMS | 7.5 | TVTMSTS | 2.5 | 0.9 |
| 6 | VPDMS | 90 | MHS-DMS | 7.5 | TETMSTS | 2.5 | 0.9 |

VPDMS: polydimethylsiloxane having vinyl at a terminal (viscosity: 1,000 cS, molecular weight: 28,000)
MHS-DMS: methylhydrogensiloxane-dimethylsiloxane copolymer (viscosity: 30 cS, molecular weight: 2,000)
TVTMSTS: 1,3,5,7-tetravinyl-1,3,5,7-tetramethylcyclotetrasiloxane (molecular weight: 344.66)
TETMSTS: 1,3,5,7-tetraethyl-2,4,6,8-tetramethylcyclotetrasilazane (molecular weight: 348.78)

TABLE 4

| Adhesive | appearance of bonded glass | | Adhesive layer |
|---|---|---|---|
| composition No. | Bubbles | clouding | shrinkage (%) |
| 4 | not seen | not seen | less than 0.1 |
| 5 | not seen | not seen | less than 0.1 |
| 6 | not seen | not seen | less than 0.1 |
| 7 | seen | seen | 60 |

TABLE 5

| | Primer composition | | | | | | | |
|---|---|---|---|---|---|---|---|---|
| | 9 | 10 | 11 | 12 | 13 | 14 | 15 | 16 |
| Tetraethoxy- | 100 | 100 | 100 | 100 | 100 | 0 | 100 | 100 |
| silane | | | | | | | | |
| Vinyltri- | 50 | 0 | 50 | 50 | 50 | 50 | 0 | 0 |
| ethoxysilane | | | | | | | | |
| Allyltri- | 0 | 50 | 0 | 0 | 0 | 0 | 0 | 0 |
| ethoxysilane | | | | | | | | |
| Tetra-n-butoxy- | 50 | 50 | 0 | 0 | 50 | 50 | 50 | 50 |
| titanium | | | | | | | | |
| Tetra-n-butoxy- | 0 | 0 | 50 | 0 | 0 | 0 | 0 | 0 |
| zirconium | | | | | | | | |
| dibutoxyAltri- | 0 | 0 | 0 | 50 | 0 | 0 | 0 | 0 |
| ethoxysilane | | | | | | | | |
| hexane | 1,000 | 1,000 | 1,000 | 1,000 | 0 | 1,000 | 1,000 | 1,000 |
| methanol | 0 | 0 | 0 | 0 | 1,000 | 0 | 0 | 0 |
| vinylpolydi- | 0 | 0 | 0 | 0 | 0 | 0 | 50 | 0 |
| methyl- | | | | | | | | |
| siloxane | | | | | | | | |
| hydrogenmeth- | 0 | 0 | 0 | 0 | 0 | 0 | 0 | 50 |
| ylpolydimeth- | | | | | | | | |
| ylsiloxane | | | | | | | | |

dibutoxyAltriethoxysilane: di-sec-butoxyaluminoxytriethoxysilane
vinylpolydimethylsiloxane: polydimethylsiloxane having vinyl at both terminals

TABLE 6

| | Primer | adhesive | bonding |
|---|---|---|---|
| | composition No. | composition No. | strength (N) |
| Ex. 7 | 9 | 4 | 13 |
| Ex. 8 | 10 | 4 | 12 |
| Ex. 9 | 11 | 4 | 14 |
| Ex. 10 | 12 | 5 | 13 |
| Ex. 11 | 13 | 6 | 12 |
| C. Ex. 7 | none | 7 | 0.3 |
| C. Ex. 8 | none | 4 | 1.2 |
| C. Ex. 9 | 14 | 4 | 1.5 |
| C. Ex. 10 | 15 | 4 | 1.6 |
| C. Ex. 11 | 16 | 5 | 1.5 |

Ex.: Example
C. Ex.: Comparative Example

What is claimed is:

1. A method of bonding an optical part, comprising the steps of:
applying a primer composition which comprises (A) 100 parts by weight of a silane compound represented by the following formula (1):
R¹Si(OR²)₃ (1)
wherein R¹ is an epoxy group-containing group and R² is an alkyl group,
(b) 5 to 500 parts by weight of a silane compound represented by the following formula (2):
Si(OR³)₄ (2)
wherein R³ is an alkyl group,
(C) 5 to 500 parts by weight of a metal alkoxide represented by the following formula (3):
M(OR⁴)ₙ (3)
wherein M is Ti, Al or Zr, R⁴ is an alkyl group or trialkoxysilyl group, and n is 4 when M is Ti or Zr and n is 3 when M is Al, with the proviso that one of three R⁴'s can be a trialkoxysilyl group when M is Al, and (D) a solvent, to the surface of an optical part to be bonded;
placing an epoxy resin adhesive composition between the primer composition coated surface of the optical part and the surface of another part to be bonded to the optical part; and
curing the epoxy resin adhesive composition.

2. The method of claim 1, wherein the silane compound (A) is at least one selected from the group consisting of 2-(3,4-epoxycyclohexylethyl)trialkoxysilane and γ-glycidoxypropyltrialkoxysilane.

3. The method of claim 1, wherein the metal alkoxide (C) is at least one selected from the group consisting of titanium tetraalkoxide, zirconium tetraalkoxide, aluminum trialkoxide and di-sec-butoxyaluminoxytriethoxysilane.

4. The method of claim 1, wherein the adhesive composition comprises a chief agent which contains at least one selected from the group consisting of bisphenol epoxy resin and novolak epoxy resin and a curing agent comprising imidazole.

5. The method of claim 1, wherein the adhesive composition comprises:
(E) 3 to 60 wt % of at least one selected from the group consisting of an epoxysilane represented by the following formula (4):
RₙSiX₄₋ₙ (4)
wherein n is 1 or 2, R is an organic group having an epoxy bond when n is 1, and at least one of R's is an organic group having an epoxy bond and the other R than it is an organic group having no epoxy bond when n is 2, and X is a hydrolyzable group or atom, and a hydrolysate or polycondensate thereof,
(F) 5 to 90 wt % of a bisphenol epoxy resin,
(G) 5 to 35 wt % of a novolak epoxy resin,
(H) 3 to 30 wt % of a curing agent comprising an amine, and
(J) 0 to 0.75 time the number of moles of the hydrolyzable group or atom of the epoxysilane of water and alcohol, the above wt % being based on 100 wt % of the components (E), (F) and (G).

6. A method of bonding an optical part, comprising the steps of:
applying a primer composition which comprises (B) 100 parts by weight of a silane compound represented by the following formula (2):
Si(OR³)₄ (2)
wherein R³ is an alkyl group,
(A′) 5 to 500 parts by weight of a silane compound represented by the following formula (1′):
R⁵Si(OR⁶)₃ (1′)
wherein R⁵ is an alkenyl group and R⁶ is an alkyl group,
(C) 5 to 500 parts by weight of a metal alkoxide represented by the following formula (3):
M(OR⁴)ₙ (3)
wherein M is Ti, Al or Zr, R⁴ is an alkyl group or trialkoxysilyl group, and n is 4 when M is Ti or Zr and n is 3 when M is Al, with the proviso that one of three R⁴'S can be a trialkoxysilyl group when M is Al, and
(D) a solvent, to the surface of an optical part to be bonded;
placing a silicon resin adhesive composition between the primer composition coated surface of the optical part and another part to be bonded to the optical part; and
curing the silicon resin adhesive composition.

7. The method of claim 6, wherein the silane compound (A′) is at least one selected from the group consisting of vinyltrialkoxysilane and allyltrialkoxysilane.

8. The method of claim 6, wherein the metal alkoxide (C) is at least one selected from the group consisting of titanium tetraalkoxide, zirconium tetraalkoxide, aluminum trialkoxide and di-sec-butoxyaluminoxytriethoxysilane.

9. The method of claim 6, wherein the adhesive composition comprises (K) an organopolysiloxane having at least two alkenyl groups with 4 or less carbon atoms bonded to a silicon atom in one molecule, (L) an organohydrogenpolysiloxane having at least two hydrogen atoms bonded to a silicon atom in one molecule, and (M) a metal catalyst.

10. The method of claim 9, wherein the organopolysiloxane (K) is a dimethylsiloxane having vinyl at both terminals, the organohydrogenpolysiloxane is a methylhydrogenpolysiloxane, and the metal catalyst is a platinum compound.

11. A primer composition for optical parts, comprising:
(A) 100 parts by weight of a silane compound represented by the following formula (1):
R¹Si(OR²)₃ (1)
wherein R¹ is an epoxy group-containing group and R² is an alkyl group,
(B) 5 to 500 parts by weight of a silane compound represented by the following formula (2):
Si(OR³)₄ (2)
wherein R³ is an alkyl group,
(C) 5 to 500 parts by weight of a metal alkoxide represented by the following formula (3):
M(OR⁴)ₙ (3)
wherein M is Ti, Al or Zr, R⁴ is an alkyl group or trialkoxysilyl group, and n is 4 when M is Ti or Zr and n is 3 when M is Al, with the proviso that one of three R⁴'S can be a trialkoxysilyl group when M is Al, and
(D) a solvent.
